(19) United States
(12) Patent Application Publication
(10) Pub. No.: US 2021/0197792 A1
(43) Pub. Date: Jul. 1, 2021

(54) VEHICLE TRAVEL CONTROL SYSTEM, VEHICLE, AND VEHICLE TRAVEL CONTROL METHOD

(71) Applicant: TOYOTA JIDOSHA KABUSHIKI KAISHA, Toyota-shi (JP)

(72) Inventors: Yoshiaki KIKUCHI, Toyota-shi (JP); Junichi MATSUMOTO, Toyota-shi (JP); Akio UOTANI, Nagoya-shi (JP)

(73) Assignee: TOYOTA JIDOSHA KABUSHIKI KAISHA, Toyota-shi (JP)

(21) Appl. No.: 17/126,996

(22) Filed: Dec. 18, 2020

(30) Foreign Application Priority Data
Dec. 26, 2019 (JP) 2019-236453

(51) Int. Cl. B60W 20/13; B60W 10/08; B60W 10/26

(52) U.S. Cl. CPC B60W 20/13; B60W 10/08; B60W 2710/248; B60W 2510/244; B60W 2510/085; B60W 10/26

(57) ABSTRACT

A travel control system for a vehicle and the vehicle includes a battery pack. The battery pack includes a battery, a current sensor configured to detect a current that is charged and discharged to and from the battery, and a first control device that monitors a state of the battery. The travel control system includes a rotary electric machine configured to consume electric power to generate a driving force and configured to generate electric power, a power conversion device electrically connected between the battery and the rotary electric machine and a second control device.

### CROSS-REFERENCE TO RELATED APPLICATION

This application claims priority to Japanese Patent Application No. 2019-236453 filed on Dec. 26, 2019, incorporated herein by reference in its entirety.

### BACKGROUND

### 1. Technical Field

The present disclosure relates to a travel control system for a vehicle, a vehicle, and a travel control method for a vehicle, and more particularly, to a travel control for a vehicle equipped with a battery.

### 2. Description of Related Art

In recent years, vehicles equipped with batteries, such as hybrid vehicles and electric cars, have become widespread in use. Hereinafter, these vehicles are also referred to as “electric vehicles”. A typical electric vehicle is provided with a plurality of electronic control units (ECUs) separated by function. For example, a hybrid vehicle disclosed in Japanese Unexamined Patent Application Publication No. 2019-156007 (JP 2019-156007 A) includes an engine ECU, a motor ECU, a battery ECU, and a hybrid vehicle (HV) ECU. The HV ECU is connected to the engine ECU, the motor ECU, and the battery ECU via communication ports, and transmits and receives various control signals and data to and from the engine ECU, the motor ECU, and the battery ECU.

### SUMMARY

Hereinafter, a configuration is assumed that a battery pack and a travel control system are mounted on an electric vehicle. The battery pack includes a battery, a current sensor that detects a current charged and discharged to and from the battery, and an ECU that monitors a state of the battery (hereinafter, referred to as a first ECU). The travel control system includes a rotary electric machine (motor generator) that is able to consume electric power to generate a driving force as well as to generate electric power, a power conversion device (inverter etc.) electrically connected between the battery and the rotary electric machine, and an ECU that controls the power conversion device (hereinafter, referred to as a second ECU). The first ECU and the second ECU are configured to be able to communicate with each other.

The automobile industry is considered to have a vertically integrated industrial structure. In the future, however, with the further spread of electric vehicles worldwide, there is a possibility that horizontal division of work regarding electric vehicles may progress.

It is conceivable that a business entity dealing with battery packs (hereinafter, company A) and a business entity dealing with travel control systems (hereinafter, company B) operate separately. For example, the company B sells a travel control system to the company A. The company A develops an electric vehicle by combining the travel control system purchased from the company B with a battery pack designed by the company A. Especially in such a situation, compatibility between the battery pack and the travel control system may become an issue.

More specifically, the company A has gained experience in “current-based” protection and use of batteries based on the convention in the secondary battery research and development field. On the other hand, the company B is familiar with “power-based” control of charging/discharging of the batteries, which is suitable for controlling power conversion devices such as inverters. Under such circumstances, what sorts of parameters are to be used for the communication between the first ECU in the battery pack and the second ECU in the travel control system may become an issue.

Specifically, it is conceivable that a current actually charged and discharged to and from the battery (detection value of the current sensor) and an “allowable current” that is a current allowed to be charged and discharged to and from the battery from the viewpoint of protecting the battery are output from the first ECU to the second ECU. It is desirable that the second ECU controls the power conversion device based on the allowable current received from the first ECU instead of the power-based parameters (power limiting values Win and Wout described later).

The present disclosure can ensure compatibility between two ECUs.

A travel control system according to an aspect of the present disclosure is a travel control system for a vehicle including a battery pack. The battery pack includes a battery, a current sensor configured to detect a current charged and discharged to and from the battery, and a first control device that monitors a state of the battery. The travel control system includes a rotary electric machine, a power conversion device, and a second control device. The rotary electric machine is configured to consume electric power to generate a driving force and is configured to generate electric power. The power conversion device is electrically connected between the battery and the rotary electric machine. The second control device has a power limit value indicating an electric power that is allowed to be charged and discharged to and from the battery, is configured to execute current feedback control, when a detection value of the current sensor exceeds a control threshold, to correct the power limit value based on an amount by which the detection value exceeds the control threshold, and is configured to control the power conversion device. The second control device is configured to receive an allowable current of the battery from the first control device and use the allowable current as the control threshold to execute the current feedback control. The allowable current is determined to protect the battery.

According to the above configuration, the second control device is configured to execute the current feedback control, when the detection value of the current sensor exceeds the control threshold, to correct the power limit value of the battery (discharging power limit value Wout described later) based on the amount by which the detection value exceeds the control threshold. As the control threshold, the allowable current output from the first control device to the second control device is used. Accordingly, the second control device can execute the current feedback control and appropriately limit the power limit value even when power-based information (power limit value) is not output from the first control device to the second control device. Thus, compatibility between the two control devices (first and second control devices) can be ensured.

In the above aspect, the second control device may be configured to execute the current feedback control using, as the control threshold, a value obtained by subtracting a predetermined margin from the allowable current.

In the above configuration, the value obtained by subtracting the margin from the allowable current is used as the control threshold. That is, the second control device is configured to start the correction of the power limit value at the time when the detection value of the current sensor reaches the value obtained by subtracting the margin from the allowable current. This suppresses the charging/discharging current of the battery from largely exceeding the allowable current. Thus, according to the above configuration, the battery can be protected more effectively.

In the above aspect, the second control device may be configured to execute the current feedback control, using a smaller one of an upper limit current determined to protect an electric component electrically connected between the battery and the power conversion device and the allowable current from the first control device, as the control threshold.

According to the above configuration, it is possible to protect the electric component (such as a wire harness in the examples described later) with the upper limit current, as well as to protect the battery with the allowable current.

A vehicle according to a second aspect of the present disclosure includes the travel control system, the battery, the current sensor, and the first control device.

According to the above configuration, compatibility between the two control devices can be ensured.

A third aspect of the present disclosure relates to a travel control method for a vehicle. The vehicle includes a battery pack and a travel control system. The battery pack includes a battery, a current sensor configured to detect a current that is charged and discharged to and from the battery, and a first control device that monitors a state of the battery. The travel control system includes a rotary electric machine configured to consume electric power to generate a driving force and configured to generate electric power, a power conversion device that is electrically connected between the battery and the rotary electric machine, and a second control device that controls the power conversion device. The travel control method includes outputting an allowable current of the battery from the first control device to the second control device, the allowable current being determined to protect the battery, and executing, with the second control device, current feedback control using the allowable current as a control threshold. The current feedback control is control to correct, when a detection value of the current sensor exceeds the control threshold, a power limit value based on an amount by which the detection value exceeds the control threshold, the power limit value indicating an electric power that is allowed to be charged and discharged to and from the battery.

According to the above configuration, compatibility between the two control devices can be ensured.

According to the present disclosure, compatibility between two control devices can be ensured.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing an overall configuration of a vehicle in the present embodiment;

FIG. 2 is a functional block diagram of a hybrid vehicle (HV) ECU related to current feedback control in the present embodiment;

FIG. 3 is a flowchart showing process procedures executed prior to the current feedback control in the present embodiment;

FIG. 4 is a functional block diagram of an HV ECU related to current feedback control in a first modification;

FIG. 5 is a flowchart showing process procedures executed prior to the current feedback control in the first modification;

FIG. 6 shows an example of a temporal change of a current and an allowable discharge current of a battery; and

FIG. 7 is a flowchart showing process procedures executed prior to current feedback control in a second modification.

### DETAILED DESCRIPTION OF EMBODIMENTS

Embodiments of the present disclosure will be described in detail with reference to the drawings. It should be noted that the same or corresponding parts in the drawings are denoted by the same reference characters and repetitive description thereof will be omitted.

Hereinafter, a configuration in which a travel control system according to the present disclosure is mounted on a hybrid vehicle will be described as an example. However, the travel control system according to the present disclosure can be mounted on other types of electric vehicles (electric cars, fuel cell vehicles, etc.).

### Embodiment

### Vehicle Overall Configuration

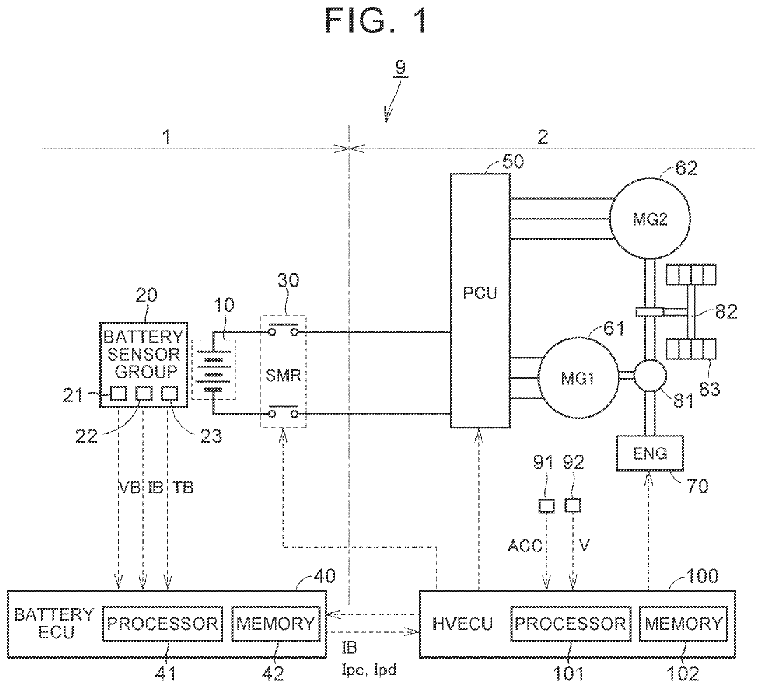

FIG. 1 is a diagram schematically showing an overall configuration of a vehicle in the present embodiment. Referring to FIG. 1, a vehicle 9 is a hybrid vehicle and includes a battery pack 1 and a hybrid vehicle (HV) system 2. The HV system 2 can be regarded as the “travel control system” according to the present disclosure.

The battery pack 1 includes a battery 10, a battery sensor group 20, a system main relay (SMR) 30, and a battery electronic control unit (ECU) 40. The HV system 2 includes a power control unit (PCU) 50, a first motor generator (MG) 61, a second motor generator 62, an engine 70, a power split device 81, a drive shaft 82, driving wheels 83, an accelerator position sensor 91, a vehicle speed sensor 92, and an HV ECU 100.

The battery 10 includes an assembled battery composed of a plurality of cells. Each cell is a secondary battery such as a lithium ion battery or a nickel-metal hydride battery. The battery 10 stores electric power for driving the first motor generator 61 and the second motor generator 62, and supplies the electric power to the first motor generator 61 and the second motor generator 62 through the PCU 50. Further, the battery 10 is charged by receiving the generated power through the PCU 50 when the first motor generator 61 and the second motor generator 62 generate electric power.

The battery sensor group 20 includes a voltage sensor 21, a current sensor 22, and a temperature sensor 23. The voltage sensor 21 detects a voltage VB of each cell included in the battery 10. The current sensor 22 detects a current D3 charged and discharged to and from the battery 10. The temperature sensor 23 detects a temperature TB of the battery 10. The sensors output the detection results to the battery ECU 40.

The SMR 30 is electrically connected to a power line connecting the battery 10 and the PCU 50. The SMR 30 switches electrical connection and disconnection between the PCU 50 and the battery 10 in accordance with a control command from the HV ECU 100.

The battery ECU 40 includes a processor 41 such as a central processing unit (CPU), a memory 42 such as a read-only memory (ROM) and a random access memory (RAM), and an input/output port (not shown) for inputting/outputting various signals. The battery ECU 40 monitors the state of the battery 10 based on the signals received from the sensors of the battery sensor group 20 and programs and maps stored in the memory 42.

Main processes executed by the battery ECU 40 includes a calculation process of an allowable charge current Ipin and an allowable discharge current Ipd of the battery 10. The allowable charge current Ipin of the battery 10 is the maximum current that is allowed to be charged to the battery 10 from the viewpoint of protecting the battery 10. Similarly, the allowable discharge current Ipd of the battery 10 is the maximum current that is allowed to be discharged from the battery 10 from the viewpoint of protecting the battery 10. The battery ECU 40 outputs the calculated allowable charge current Ipin and the calculated allowable discharge current Ipd to the HV ECU 100. Note that either or both of the allowable charge current Ipin and the allowable discharge current Ipd can be regarded as the “allowable current” according to the present disclosure.

The PCU 50 performs bidirectional power conversion between the battery 10 and the first and second motor generators 61, 62, or between the first motor generator 61 and the second motor generator 62, in accordance with a control command from the HV ECU 100. The PCU 50 is configured to be able to control the states of the first motor generator 61 and the second motor generator 62 individually. More specifically, the PCU 50 includes, for example, two inverters (not shown) provided corresponding to the first motor generator 61 and the second motor generator 62, and a converter (not shown) that boosts a direct-current (DC) voltage supplied to each inverter to an output voltage of the battery 10 or higher. Therefore, for example, the PCU 50 can bring the second motor generator 62 into the power running state while putting the first motor generator 61 in the regenerative state (power generation state).

The PCU 50 can be regarded as the “power conversion device” according to the present disclosure. However, when the vehicle 9 is configured to be capable of “external charging” for charging the battery 10 with electric power supplied from the outside (for example, when the vehicle is a plug-in hybrid vehicle), the “power conversion device” according to the present disclosure may be a charger that converts electric power from outside the vehicle into charging power for the battery 10.

Each of the first motor generator 61 and the second motor generator 62 is an alternating-current (AC) rotary electric machine, and for example, a three-phase AC synchronous motor in which permanent magnets are embedded in a rotor. At least one of the first motor generator 61 and the second motor generator 62 can be regarded as the “rotary electric machine” according to the present disclosure.

The first motor generator 61 is mainly used as a generator driven by the engine 70 via the power split device 81. The electric power generated by the first motor generator 61 is supplied to the second motor generator 62 or the battery 10 via the PCU 50. The first motor generator 61 can also crank the engine 70.

The second motor generator 62 mainly operates as an electric motor and drives the driving wheels 83. The second motor generator 62 is driven by receiving at least one of the electric power from the battery 10 and the electric power generated by the first motor generator 61, and the driving force of the second motor generator 62 is transmitted to a drive shaft (output shaft) 72. On the other hand, when the vehicle is being braked or the acceleration is being reduced on the descending slope, the second motor generator 62 operates as a generator to perform regenerative power generation. The electric power generated by the second motor generator 62 is supplied to the battery 10 via the PCU 50.

The engine 70 outputs power by converting combustion energy generated when a mixture of air and fuel is burned, into kinetic energy of a moving element such as a piston or a rotor.

The power split device 81 is, for example, a planetary gear device. Although not shown, the power split device 81 includes a sun gear, a ring gear, a pinion gear, and a carrier. The carrier is connected to the engine 70. The sun gear is connected to the first motor generator 61. The ring gear is connected to the second motor generator 62 and the driving wheels 83 via the drive shaft 82. The pinion gear meshes with the sun gear and the ring gear. The carrier holds the pinion gear so that the pinion gear can rotate and revolve.

The accelerator position sensor 91 detects the amount of depression of an accelerator pedal (not shown) by a user as an accelerator operation amount ACC, and outputs the detection result to the HV ECU 100. The vehicle speed sensor 92 detects the rotation speed of the drive shaft 82 as a vehicle speed V and outputs the detection result to the HV ECU 100.

Like the battery ECU 40, the HV ECU 100 includes a processor 101 such as a CPU, a memory 102 such as a ROM and a RAM, and an input/output port (not shown). The HV ECU 100 executes travel control of the vehicle 9 based on the data from the battery ECU 40 and the programs and the maps stored in the memory 102. Details of the control will be described later.

The battery ECU 40 can be regarded as the “first control device” according to the present disclosure. The HV ECU 100 can be regarded as the “second control device” according to the present disclosure. The HV ECU 100 may be further divided into a plurality of ECUs (engine ECU, MG ECU, etc.) by function, as described in JP 2019-156007 A.

### Communication Between ECUs

The automobile industry is considered to have a vertically integrated industrial structure. In the future, however, with the further spread of electric vehicles worldwide, there is a possibility that horizontal division of work regarding electric vehicles may progress. The inventors of the present disclosure have focused on the point that the following issues may arise when such a transformation of the industrial structure progresses.

It is conceivable that a business entity dealing with the battery pack 1 (hereinafter, company A) and a business entity dealing with the HV system 2 (hereinafter, company B) operate separately. For example, the company B sells the HV system 2 to the company A. The company A develops the vehicle 9 by combining the HV system 2 purchased from the company B with the battery pack 1 designed (or procured) by the company A. Especially in such a situation, compatibility between the battery pack 1 and the HV system 2 may become an issue.

More specifically, the company A has gained experience in current-based protection and use of the battery 10 based on the convention in the secondary battery research and development field. On the other hand, the company B is familiar with power-based control of charging/discharging of the battery 10, which is suitable for controlling the PCU 50. The company B uses a charging power control upper limit value Win that is the control upper limit value of the charging power to the battery 10 and a discharging power limit value Wout that is the control upper limit value of the discharging power from the battery 10, for charge/discharge control of the battery 10. In this case, the HV ECU 100 only needs to be able to receive the charging power control upper limit value Win and the discharging power limit value Wout of the battery 10 from the battery ECU 40. However, the company A is not familiar with the technique to output the charging power control upper limit value Win and the discharging power limit value Wout from the battery ECU 40. Thus, what sorts of parameters should be used for the communication between the battery ECU 40 and the HV ECU 100 (which of the current-based communication and the power-based communication is performed) may become an issue.

In the present embodiment, it is assumed that the current-based communication is performed based on the intention of the company A, to which the company B sells the HV system 2. Specifically, as described above, the battery ECU 40 outputs to the HV ECU 100 the allowable charge current Ipin and the allowable discharge current Ipd that are allowed to be charged and discharged to and from the battery 10 in order to protect the battery 10. The HV ECU 100 executes the feedback control for the PCU 50 based on the allowable charge current Ipin and the allowable discharge current Ipd received from the battery ECU 40. This control is referred to as “current feedback control” and will be described in detail.

The current feedback control at the time of charging of the battery 10 and the current feedback control at the time of discharging of the battery 10 are basically the same. Therefore, in the following, the current feedback control based on the allowable discharge current Ipd at the time of discharging of the battery 10 will be representatively described. Regarding the charging/discharging direction (signs of current and power) of the battery 10, the positive direction is defined as the discharging direction and the negative direction is defined as the charging direction.

### Current Feedback Control

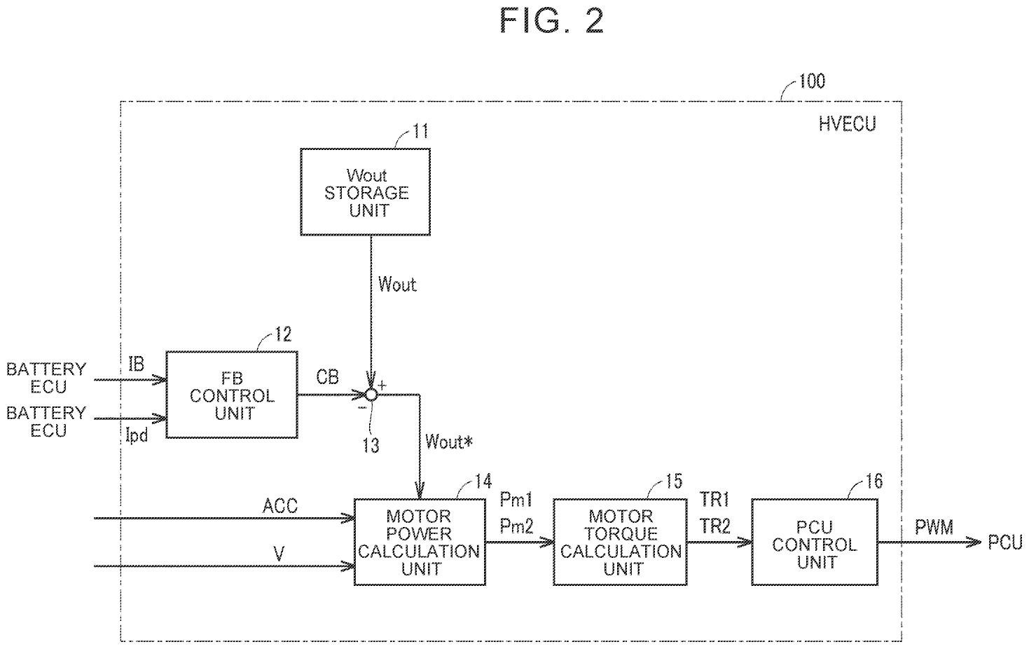

FIG. 2 is a functional block diagram of the HV ECU 100 related to the current feedback control in the present embodiment. Referring to FIG. 2, the HV ECU 100 includes a Wout storage unit 11, a feedback control unit 12, a subtraction unit 13, a motor power calculation unit 14, a motor torque calculation unit 15, and a PCU control unit 16.

The Wout storage unit 11 stores the discharging power limit value Wout. The discharging power from the battery 10 is limited so as not to exceed the discharging power limit value Wout. The discharging power limit value Wout may be a fixed value or may be a variable value that is calculated in accordance with the temperature TB and/or the state of charge (SOC) of the battery 10. The Wout storage unit 11 outputs the discharging power limit value Wout of the battery 10 to the subtraction unit 13.

The feedback control unit 12 receives a detection value of the current D3 from the battery ECU 40 at regular cycles (for example, several hundred milliseconds). The battery ECU 40 may perform a smoothing process (gradual change process) on the signal (detection value) from the current sensor 22 and output the value after the smoothing process to the feedback control unit 12. The smoothing process is, for example, a process of averaging the detection values of the current sensor 22 with a predetermined time constant.

The feedback control unit 12 is configured to execute current feedback control for controlling the current such that the current D3 falls below a control threshold TH when the detection value of the current D3 exceeds the control threshold TH. The feedback control unit 12 receives the allowable discharge current Ipd of the battery 10 from the battery ECU 40, in addition to the detection value of the current IB. Then, the feedback control unit 12 substitutes the allowable discharge current Ipd into the control threshold TH and executes the current feedback control. The calculation result of the current feedback control is output to the subtraction unit 13 as a control amount CB for correcting the discharging power limit value Wout of the battery 10.

The subtraction unit 13 subtracts the control amount CB output from the feedback control unit 12 from the discharging power limit value Wout, and outputs the calculation result to the motor power calculation unit 14 as a correction value Wout* of the discharging power limit value Wout (Wout*=Wout−CB).

The motor power calculation unit 14 receives the accelerator operation amount ACC from the accelerator position sensor 91 and the vehicle speed V from the vehicle speed sensor 92. Based on the accelerator operation amount ACC, the vehicle speed V, and the like, the motor power calculation unit 14 calculates a motor power Pm1 required for the first motor generator 61 and a motor power Pm2 required for the second motor generator 62. When the total value (Pm1+Pm2) of the motor power Pm1, Pm2 exceeds the correction value Wout*, the total value (Pm1+Pm2) is limited to the correction value Wout*.

The motor torque calculation unit 15 calculates a torque command value TR1 indicating the torque required for the first motor generator 61, based on the motor power Pm1 from the motor power calculation unit 14. Further, the motor torque calculation unit 15 calculates a torque command value TR2 indicating the torque required for the second motor generator 62, based on the motor power Pm2 from the motor power calculation unit 14. Further, the PCU control unit 16 generates a pulse width modulation (PWM) signal for causing the first motor generator 61 and the second motor generator 62 to output torque in accordance with the torque command values TR1, TR2, respectively. Then, the motor torque calculation unit 15 outputs the generated PWM signal to the PCU 50.

### Process Flow

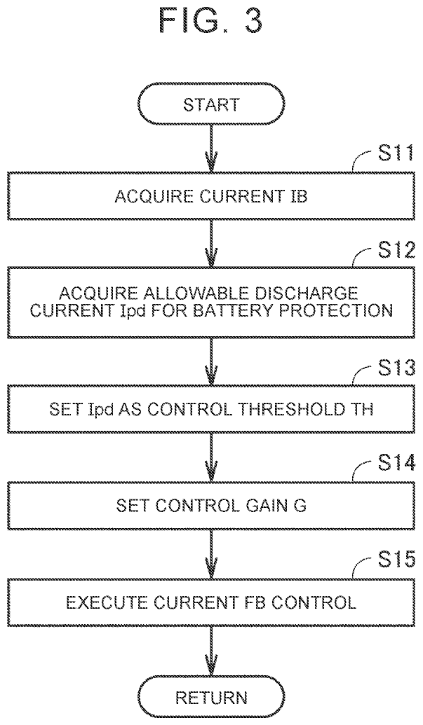

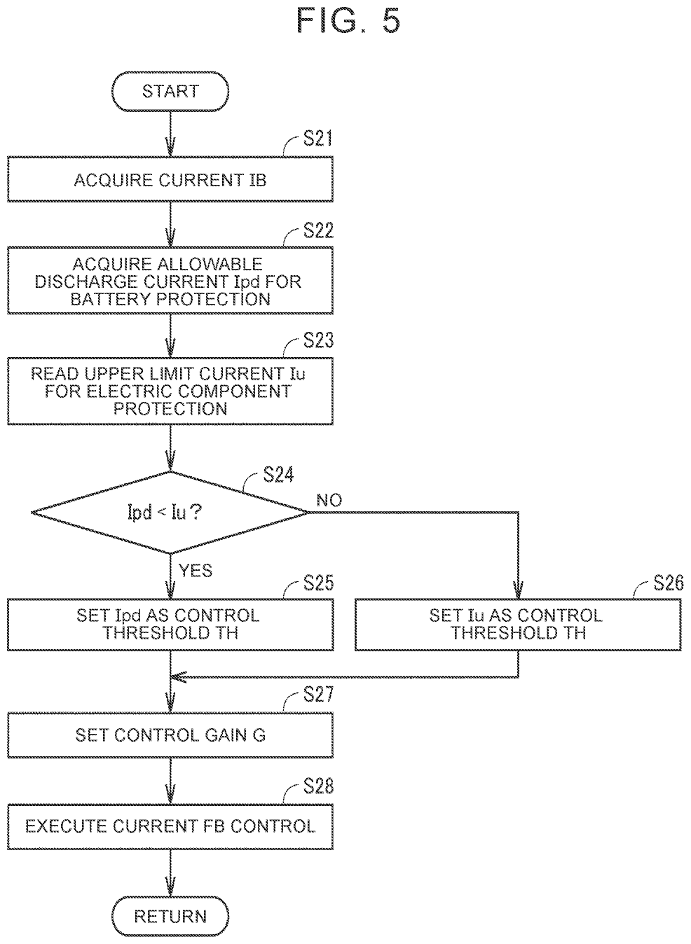

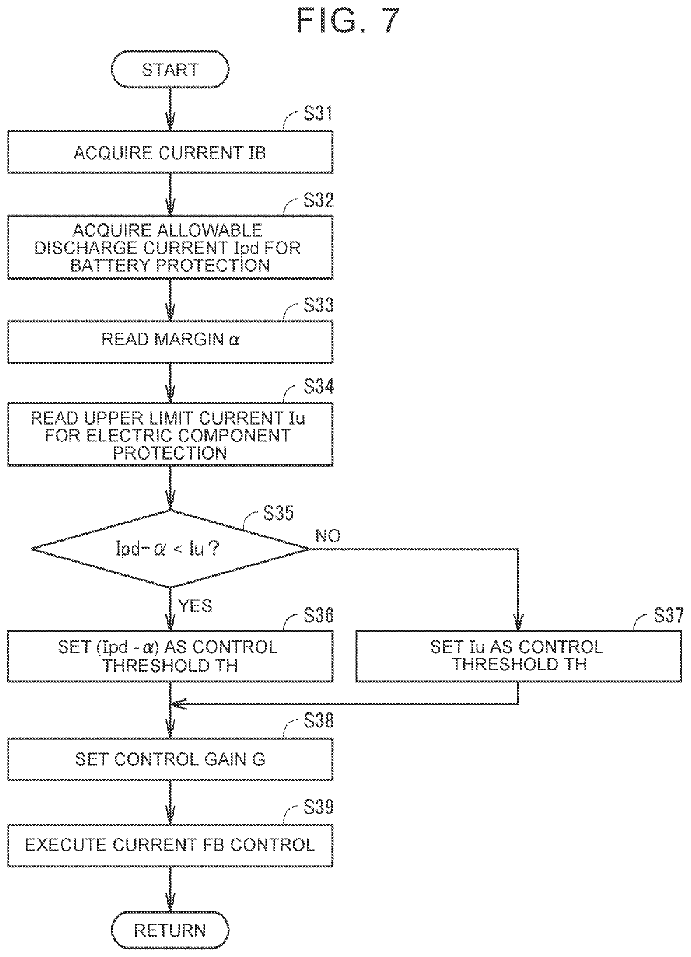

FIG. 3 is a flowchart showing process procedures executed prior to the current feedback control in the present embodiment. The processes shown in the flowchart in FIG. 3 and the flowcharts in FIGS. 5 and 7, described later, are each called from a main routine (not shown) and executed, for example, at every predetermined control cycle. Each step included in these flowcharts is basically implemented by software processing by the HV ECU 100, but may be implemented by dedicated hardware (electric circuit) provided in the HV ECU 100. Hereinafter, the term “step” will be abbreviated as “S”.

Referring to FIG. 3, in S11, the HV ECU 100 acquires the detection value of the current D3 from the current sensor 22 via the battery ECU 40.

In S12, the HV ECU 100 acquires from the battery ECU 40 the allowable discharge current Ipd of the battery 10, which is determined to protect the battery 10. The allowable discharge current Ipd is determined in accordance with the temperature TB of the battery 10 and the deterioration state of the battery 10 in order to protect the battery 10. Here, the deterioration of the battery 10 may include age deterioration of the battery 10. Furthermore, when the battery 10 is a lithium ion battery, the deterioration of the battery 10 may include deterioration in which lithium metal is deposited on the negative electrode surface of the lithium ion battery (so-called lithium deposition).

In S13, the HV ECU 100 sets the allowable discharge current Ipd (TH=Ipd) as the control threshold TH used for the current feedback control.

In S14, the HV ECU 100 sets a control gain G of the current feedback control. For example, the HV ECU 100 sets the control gain G at a predetermined value. Then, the HV ECU 100 executes the current feedback control using the control threshold TH and the control gain G set in S13 and S14 (S15). Specifically, the HV ECU 100 executes feedback control (for example, proportional-integral (PI) control) using a value obtained by subtracting the control threshold TH from the current IB as a control input (control amount CB) and using a predetermined value as the control gain G, when the current IB exceeds the control threshold TH.

As described above, in the present embodiment, the HV ECU 100 does not receive discharging power limit value Wout of the battery 10 from the battery ECU 40. The HV ECU 100 executes the current feedback control, when the detection value of the current sensor 22 (current IB) exceeds the control threshold TH, to correct the discharging power limit value Wout of the battery 10 based on the amount by which the detection value exceeds the control threshold TH. The allowable discharge current Ipd output from the battery ECU 40 to the HV ECU 100 is used as the control threshold TH. Thus, the HV ECU 100 can perform current limitation such that the current IB does not largely exceed the control threshold TH even when power-based information (discharging power limit value Wout) is not output from the battery ECU 40 to the HV ECU 100.

### First Modification

In the present modification, control for achieving both protection of the battery 10 and protection of electric components other than the battery 10 will be described. In the first modification, an HV ECU 100A is used instead of the HV ECU 100.

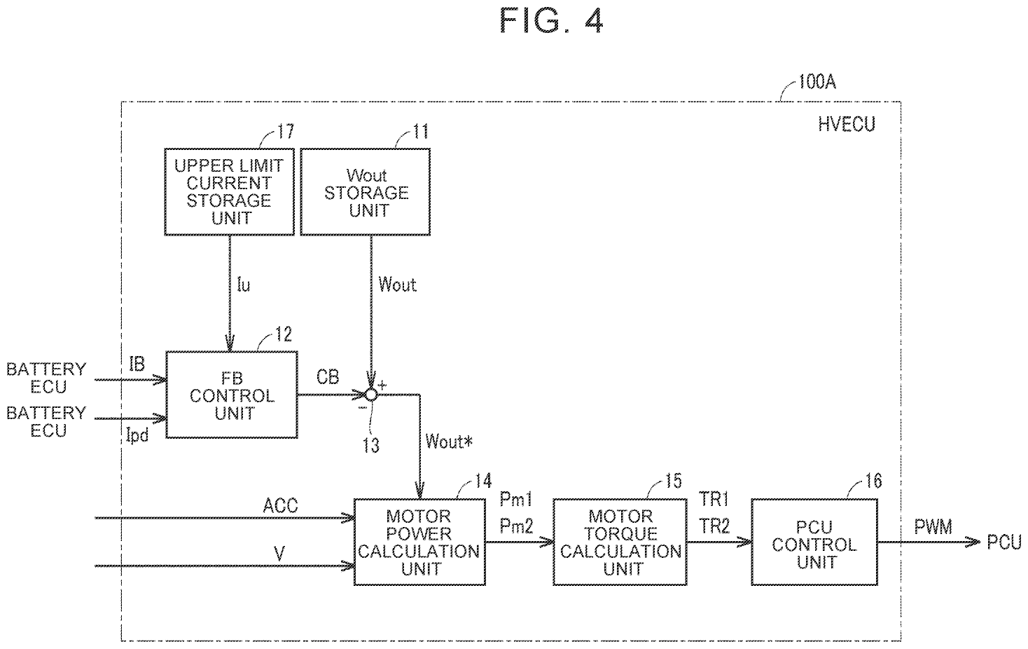

FIG. 4 is a functional block diagram of the HV ECU 100A related to current feedback control in the first modification. Referring to FIG. 4, the HV ECU 100A differs from the HV ECU 100 (see FIG. 2) according to the embodiment in that an upper limit current storage unit 17 is further included.

The upper limit current storage unit 17 stores an “upper limit current Iu” that is a current determined from the viewpoint of protecting the electric components electrically connected between the battery 10 and the PCU 50. The upper limit current Iu is determined in advance based on the rated current of the wire harness, the rated current of the fuse provided in the battery 10, or the like. However, the electric components related to the upper limit current Iu is not limited to these examples, and may be, for example, a diode (a device connected in antiparallel to a switching element) that constitutes a converter inside the PCU 50. The upper limit current storage unit 17 outputs the upper limit current Iu to the feedback control unit 12.

Similar to the embodiment, the feedback control unit 12 executes the current feedback control that controls the current such that the current IB does not exceed the control threshold TH when the detection value of the current IB exceeds the control threshold TH. However, in the first modification, the feedback control unit 12 receives not only the allowable discharge current Ipd of the battery 10 from the battery ECU 40 but also the upper limit current Iu from the upper limit current storage unit 17. The feedback control unit 12 substitutes the smaller one of the allowable discharge current Ipd and the upper limit current Iu into the control threshold TH, and executes the current feedback control. The calculation result of the current feedback control is output to the subtraction unit 13 as the control amount CB for correcting the discharging power limit value Wout of the battery 10.

FIG. 5 is a flowchart showing process procedures executed prior to the current feedback control in the first modification. Referring to FIG. 5, the HV ECU 100A first acquires the detection value of the current IB from the current sensor 22 (S21). In S22, the HV ECU 100A acquires from the battery ECU 40 the allowable discharge current Ipd of the battery 10, which is determined to protect the battery 10.

In S23, the HV ECU 100A reads from the memory 102 the upper limit current Iu determined for protecting the electric components. As described above, the upper limit current Iu is a fixed value determined in advance for protecting the wire harness, the fuse, the diode, and the like.

In S24, the HV ECU 100A compares the allowable discharge current Ipd with the upper limit current Iu, and determines whether the allowable discharge current Ipd is smaller than the upper limit current Iu. When the allowable discharge current Ipd is smaller than the upper limit current Iu (YES in S24), the HV ECU 100A advances the process to S25 and sets the allowable discharge current Ipd as the control threshold TH used for the current feedback control (TH=Ipd). On the other hand, when the upper limit current Iu is equal to or smaller than the allowable discharge current Ipd (NO in S24), the HV ECU 100A advances the process to S26 and sets the upper limit current Iu as the control threshold TH (TH=Iu).

Subsequent processes of S27 and S28 are similar to the processes of S14 and S15 (see FIG. 3) in the embodiment, and therefore detailed description thereof will be omitted.

As described above, also in the first modification, similarly to the embodiment, the current limitation can be performed such that the current IB does not largely exceed the control threshold TH even when the discharging power limit value Wout is not output from the battery ECU 40 to the HV ECU 100A. In the first modification, the smaller one of the allowable discharge current Ipd for protecting the battery 10 and the upper limit current Iu determined in advance for protecting the electric components is used as the control threshold TH. Thereby, both the battery 10 and the electric components can be appropriately protected.

### Second Modification

In the current feedback control, the higher the control gain G is set, the stronger the feedback acts and the less the current IB exceeds the control threshold TH. On the other hand, when the control gain G is set to a value that is too high, the current limitation becomes excessively strict and the drivability of the vehicle 9 may deteriorate. When the control gain G is not set high enough, the feedback action is weak and the current IB may exceed the control threshold TH relatively largely (overshoot). In the second modification, a configuration example in which measures to overshoot of the current D3 are added will be described. In the second modification, an HV ECU 100B is used instead of the HV ECU 100.

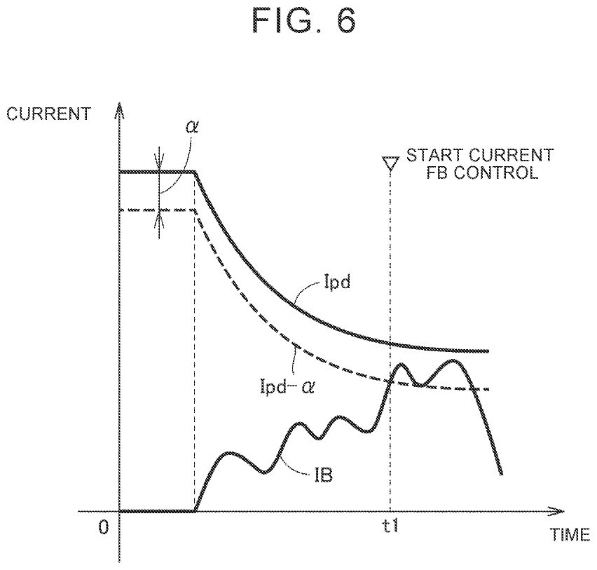

FIG. 6 shows an example of a temporal change of the current IB and the allowable discharge current Ipd of the battery 10. In FIG. 6, the horizontal axis represents elapsed time and the vertical axis represents the current.

Referring to FIG. 6, in the second modification, a margin α is provided for the allowable discharge current Ipd. The margin a is determined in advance and stored in the memory 102 of the HV ECU 100B. The margin α can be set to, for example, about 1/10 of the allowable discharge current Ipd. When the current IB reaches a value (Ipd−α) that is smaller than the allowable discharge current Ipd by the margin α at time t1, the correction of the discharging power limit value Wout is started. This makes it possible to restrain the state in which the current IB exceeds the allowable discharge current Ipd from occurring, and to eliminate the state in which the current IB exceeds the allowable discharge current Ipd in a short time.

FIG. 7 is a flowchart showing process procedures executed prior to the current feedback control in the second modification. Referring to FIG. 7, the HV ECU 100B first acquires the detection value of the current IB from the current sensor 22 (S31). Further, the HV ECU 100B acquires the allowable discharge current Ipd of the battery 10 from the battery ECU 40 (S32).

In S33, the HV ECU 100B reads from the memory 102 the margin α provided for the allowable discharge current Ipd. Further, in S34, the HV ECU 100B reads from the memory 102 the upper limit current Iu determined in advance.

In S35, the HV ECU 100B compares the value (Ipd−α) obtained by subtracting the margin α from the allowable discharge current Ipd with the upper limit current Iu. When the difference (Ipd−α) is smaller than the upper limit current Iu (YES in S35), the HV ECU 100B sets (Ipd−α) as the control threshold TH used for current feedback control (S36). On the other hand, when the upper limit current Iu is equal to or smaller than the difference (Ipd−α) (NO in S35), the HV ECU 100B sets the upper limit current Iu as the control threshold TH (S37).

Subsequent processes of S38 and S39 are similar to the processes of S14 and S15 (see FIG. 3) in the embodiment, and therefore description thereof will be omitted.

As described above, also in the second modification, similarly to the embodiment or the first modification, the current limitation can be performed such that the current D3 does not largely exceed the control threshold TH even when the discharging power limit value Wout is not output from the battery ECU 40 to the HV ECU 100B. In the second modification, when the HV ECU 100B receives the allowable discharge current Ipd from the battery ECU 40, the HV ECU 100B uses the value (Ipd−α) obtained by subtracting the margin α from the allowable discharge current Ipd to set the control threshold TH. As a result, the current feedback control (correction of the discharging power limit value Wout) is started when the current IB reaches (Ipd−α). Thus, even when the control gain G is relatively low and the overshoot of the current D3 is likely to occur, it is possible to suppress the current IB from largely exceeding the allowable discharge current Ipd. As a result, according to the second modification, the battery 10 can be protected more effectively.

The embodiment disclosed herein should be considered as illustrative and not restrictive in all respects. The scope of the present disclosure is shown by the claims, rather than the above embodiment, and is intended to include all modifications within the meaning and the scope equivalent to those of the claims.

What is claimed is:

1. A travel control system for a vehicle, the vehicle including a battery pack, and the battery pack including a battery, a current sensor configured to detect a current that is charged and discharged to and from the battery, and a first control device that monitors a state of the battery, the travel control system comprising:
a rotary electric machine configured to consume electric power to generate a driving force and configured to generate electric power;
a power conversion device electrically connected between the battery and the rotary electric machine; and
a second control device, wherein:
the second control device has a power limit value indicating an electric power allowed to be charged and discharged to and from the battery, is configured to execute current feedback control, when a detection value of the current sensor exceeds a control threshold, to correct the power limit value based on an amount by which the detection value exceeds the control threshold, and is configured to control the power conversion device; and
the second control device is configured to receive an allowable current of the battery from the first control device and use the allowable current as the control threshold to execute the current feedback control, the allowable current being determined to protect the battery.

2. The travel control system according to claim 1, wherein the second control device is configured to execute the current feedback control using, as the control threshold, a value obtained by subtracting a predetermined margin from the allowable current.

3. The travel control system according to claim 1, wherein the second control device is configured to execute the current feedback control using, as the control threshold, a smaller one of an upper limit current determined to protect an electric component electrically connected between the battery and the power conversion device and the allowable current.

4. A vehicle comprising:
the travel control system according to claim 1;
the battery;
the current sensor; and
the first control device.

5. A travel control method for a vehicle, the vehicle including a battery pack and a travel control system, the battery pack including a battery, a current sensor configured to detect a current that is charged and discharged to and from the battery, and a first control device that monitors a state of the battery, and the travel control system including a rotary electric machine configured to consume electric power to generate a driving force and configured to generate electric power, a power conversion device electrically connected between the battery and the rotary electric machine, and a second control device that controls the power conversion device, the travel control method comprising:
outputting an allowable current of the battery from the first control device to the second control device, the allowable current being determined to protect the battery; and
executing, with the second control device, current feedback control using the allowable current as a control threshold, wherein
the current feedback control is control to correct, when a detection value of the current sensor exceeds the control threshold, a power limit value based on an amount by which the detection value exceeds the control threshold, the power limit value indicating an electric power that is allowed to be charged and discharged to and from the battery.
